(19) United States
(12) Patent Application Publication
(10) Pub. No.: US 2025/0257606 A1
(43) Pub. Date: Aug. 14, 2025

(54) GLASS PACKAGE UNIT

(71) Applicants: Dmytro Stanislavovych Sandler, Kyiv (UA); Andrii Mysko, Kyiv (UA)

(72) Inventor: Dmytro Stanislavovych Sandler, Kyiv (UA)

(21) Appl. No.: 18/855,104

(22) PCT Filed: May 23, 2023
(86) PCT No.: PCT/UA2023/000027

§ 371 Date: Oct. 8, 2024

(30) Foreign Application Priority Data
Oct. 10, 2022 (UA) U 2022 03755

(51) Int. Cl. E06B 3/663

(52) U.S. Cl. CPC E06B 3/66352

(57) ABSTRACT

The claimed technical solution belongs to the means used in frame doors, windows or other locking elements, facade elements or internal partitions. The field of application of the claimed technical solution is construction, in particular, decoration of the facade, arrangement of the interior of the premises. In the inner part of the hermetic chamber, a layer of adhesive is applied to each sheet of glass, where the layer is applied in a continuous strip, which has a depth greater than the size of the fastening element used when installing the glass package unit. This ensures an increase in the strength and rigidity of the glass package unit.

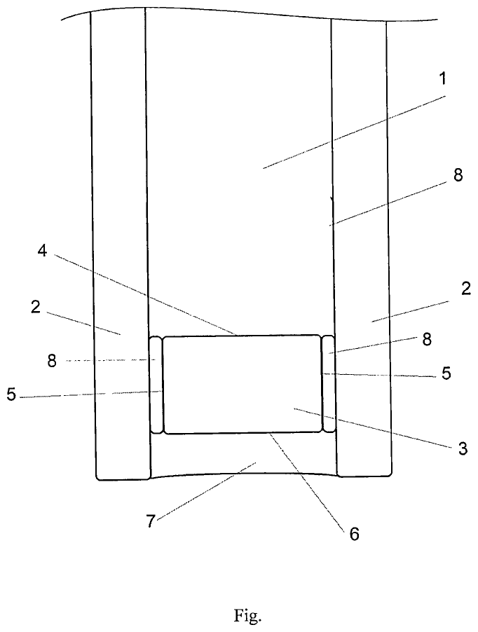

### TECHNICAL FIELD

The claimed technical solution belongs to the means used in frame doors, windows or other locking elements, facade elements or internal partitions. The field of application of the claimed technical solution is construction, in particular, decoration of the facade, arrangement of the interior of the premises.

### PRIOR ART

From the prior art, a solution is known according to the author's certificate SU 669045 «CTEKJIOITAKET» (“GLASS PACKAGE UNIT”), which teach that sheets of glass are placed parallel to each other and hermetically adhesived to an empty metal spacer frame. Thiokol sealant is applied along the inner contour of the spacer frame.

The known decision provides high thermal conductivity of the glass unit, but has low rigidity. For installation of glass package unit without a frame, the known technical solution requires the use of additional plastic and aluminum reinforcing profiles, which complicates the production of glass package units and increases the probability of defects. This leads to a significant limitation of the use of known glass package units in construction and the requirement of moderate conditions for its operation.

It has also been established that the use of thiokol sealant under the impact of an aggressive environment is causes loss of its properties, which leads to the depressurization of the glass package unit. The task of the claimed technical solution is to create a glass package unit with a significant advantages, which are manifested in the increased strength of the glass package unit and resistance to an aggressive environment. Due to its considerable strength and rigidity, the created glass package unit does not require additional structures, namely plastic, aluminum, polymer systems for installation, etc. This solution can be used both for facade works and for interior decoration.

### BRIEF DESCRIPTION OF THE INVENTION

The task is achieved due to the fact that a glass package unit, which contains at least two sheets of glass, alternately separated from each other by a distance frame, and the distance frame and two sheets of glass adjacent to it are connected to each other to form a hermetic chamber between them,
according to the technical decision,
the distance frame has two sides, an inner side and an outer side,
the hermetic chamber is formed by joining the sides of the distance frame to two sheets of glass with an adhesive, where each sheet of glass faces one side of the distance frame,
the distance frame has a perimeter on the outside that is smaller than the perimeter of the sheet of glass that is connected to the distance frame,
and the adhesive is applied in a layer along the endfaces of the glass package unit on the outer surface of the distance frame between two sheets of glass, and the outer perimeter of the layer of adhesive is not greater than the perimeter of at least one of the sheets of glass that form a hermetic chamber,
and the layer of adhesive is applied with the possibility of using it as a basis for installing fastening elements, where this possibility is determined by the thickness of the layer of adhesive.

According to one of the options, a material based on epoxy resins is used as adhesive.

According to another option, a polyurethane-based material is used as adhesive.

According to another embodiment, a plastic adhesive substance capable of hardening is used as adhesive.

The technical result achieved by the implementation of the claimed technical solution is as follows:
due to the fact that the distance frame has a perimeter on the outside, which is smaller than the perimeter of the glass sheet that is connected to the distance frame, and the fact that the adhesive is applied in a layer along the perimeter of the glass package unit on the outer surface of the distance frame between two sheets of glass, a hermetic chamber can be attached both to window or door frames, and to a concrete, brick or wooden surface if there are fasteners in the endfaces of the glass unit of the brackets;
due to the fact that the outer perimeter of the adhesive layer is not larger than the perimeter of at least one of the sheets of glass that form the hermetic chamber, less preparatory work is required for installing the glass package unit, since the endface has a flat surface;
due to the fact that the layer of adhesive is applied with the possibility of its use as a basis for the installation of fastening elements, where the specified possibility is determined by the thickness of the layer of adhesive, a new approach to the creation of glass package units is provided. Namely: firstly, the strength of the glass package unit is increased in general, since the stress distribution of the glass sheet occurs by the formation of additional zones of contact of the glass sheet on the adhesive layer. As the area of contact between the glass sheet and the adhesive layer increases, the tension decreases and the strength increases. Secondly, the thickness of the adhesive layer during the production of glass package units is adjustable, that is, the location of the distance frame depends on the selected thickness. This allows you to adjust the above-mentioned increase in strength and stiffness, in accordance with the conditions and features of its installation and operation. At the same time, the adhesive layer does not significantly affect consumer properties, such as the visibility of the glass package unit.

Additional technical properties of the claimed technical solution are the reduction of requirements for the places of installation of glass package units, since the claimed structure does not significantly gain additional mass when increasing strength and rigidity. Therefore, for the claimed glass package unit, a typical method of installation is attachment directly to the wall, floor, ceiling, etc., using mounting brackets that are attached to the endface of the glass package unit. It is possible to use glass package units as a material for room zoning, as a supporting material (for example, for laying railings, “transparent floor”, for installing an escalator belt, etc.). Glass package unit can be used for mounting transparent dome structures, such as a transparent roof, greenhouses, etc.

In addition, due to the fact that a polyurethane or epoxy-based material or a plastic adhesive capable of hardening is selected as the adhesive, are provided:
the possibility of screwing fasteners (screws, self-tapping screws, etc.) into the layer of adhesive on the endface of the glass package unit for subsequent attachment of brackets,
a significant increase in the strength and rigidity of the glass package unit due to the fact that, after drying, the adhesive layer transmits its inherent rigidity to the sheet of glass on which it is applied.

Also, the use of the specified adhesive affects the achievement of the above characteristics. At the same time, the strength indicators, the duration of the state of tightness and other properties of the glass unit do not deteriorate.

The essence of the claimed technical solution is explained with the help of a drawing, which is informative in nature and does not limit the possible options for the execution of the glass unit. In particular, a skilled person in this field should be clear about all possible options for the implementation of a technical solution that fall under the scope of patent protection of the formula.

### BRIEF DESCRIPTION OF DRAWINGS

The following notations are used in the attached drawing Figs:
1—hermetic chamber
2—sheet of glass
3—distance frame
4—the inner side of the distance frame
5—the side of the distance frame
6—the outer side of the distance frame
7—a layer of adhesive applied in a continuous strip extending from the edge of the glass sheet to the center of the glass sheet
8—a layer of adhesive applied in a continuous strip to the sides of the distance frame.

### DETAILED DESCRIPTION OF THE INVENTION

The glass package unit containing two sheets of glass separated by a distance frame is usually called a single-chamber glass package unit. Increasing the number of glass sheets and distance frames per unit allows you to get two, three or more hermetic chambers. Hermetic chambers are formed by combining in places near the periphery two adjacent sheets of glass of a hermetic remote partition. In particular, the hermetic chamber is formed by combining the sides of the distance frame with two sheets of glass using adhesive. When the adhesive dries, a complete construction of the hermetic chamber is formed from two sheets of glass facing each side of the distance frame. Such processes as filling the hermetic chamber with argon are not part of the essence of the claimed technical solution, as they are obvious to a specialist in this field and do not affect the achievement of the claimed technical result.

The distance frame has two sides, an inner side and an outer side, where the designation of the names of the sides is determined by their reference to the sheets of glass, endfaces, etc. Since the distance frame is attached to the side of the sheet of glass with its entire area, the distance frame has a perimeter on the outside that is smaller than the perimeter of the sheet of glass that is connected to the distance frame. That is, a recess is formed at the endface of the glass package unit, caused by the difference in the perimeters of the distance frame and the glass sheets.

The structurally formed notch was used to fill with adhesive. That is, the adhesive is applied in a layer along the endfaces of the glass package unit on the outer surface of the distance frame between two sheets of glass. The adhesive is filled at the endfaces mainly to the level between two adjacent sheets of glass. However, when drying, the adhesive layer reduces its thickness due to the evaporation of volatile substances.

As a result, in the finished design of the glass package unit, the outer perimeter of the adhesive layer is not greater than the perimeter of at least one of the glass sheets that form the hermetic chamber. This allows you to get such a surface of the endface of the glass package unit, which can be mounted on the frame or on the bracket without preliminary treatment.

The main advantage of the claimed technical solution is that the distance between the endfaces of the glass sheets to the distance frame is determined by production and/or design necessity. That is, depending on the place and method of fastening the glass package unit, choose the necessary distance of the distance frame from the endfaces of the glass package unit. It is clear that the layer of adhesive should have a size (thickness) that would not allow the fastening elements to contact the distance frame to avoid its damage. Fasteners currently range in length from 5 mm to 250 mm, particularly from 25 mm to 70 mm. However, the depth at which the distance frame is placed can be determined by the presence of approved requirements for the fastening of the glass package unit, and accordingly, the glass package unit can be manufactured in compliance with these conditions.

It is worth noting that the layer of adhesive in combination with the distance frame forms a stiffening rib, which, when combined with a sheet of glass, provides its reinforcement. It was found that this application of adhesive significantly increases the strength and rigidity of the glass package unit structure, which allows the use of the claimed technical solution under conditions of increased load, for example, strong wind, which puts pressure on the mounted glass package unit. It is important that the adhesive is applied with a solid mass, that is, there are no joints between the layer of adhesive applied to the endface of the glass package unit and the strip that is applied along the sides of the distance frame. This simultaneously simplifies the production of glass package units and strengthens the structure.

Epoxy adhesive or polyurethane adhesive or others, the parameters of which will be satisfied, can be used as adhesive. When each of the proposed adhesive implementation options solidifies, a dense continuous solid layer of adhesive is formed. However, a specialist in this field may be aware of other variants of the embodiment of this feature, i.e. such adhesive substances, which acquire high strength and rigidity upon solidification.

Based on the above description, the specialist should be able to understand all the possible implementation options of the claimed technical solution, which fall under the scope of patent protection, which is defined by the attached formula.

1. A glass package unit, which contains at least two sheets of glass, alternately separated from each other by a distance frame, and the distance frame and two sheets of glass adjacent to it are connected to each other to form a hermetic chamber between them,
wherein
the distance frame has two sides, an inner side and an outer side,
the hermetic chamber is formed by joining the sides of the distance frame to two sheets of glass with an adhesive, where each sheet of glass faces one side of the distance frame,
the distance frame has a perimeter on the outside that is smaller than the perimeter of the sheet of glass that is connected to the distance frame,
and the adhesive is applied in a layer along the endfaces of the glass package unit on the outer surface of the distance frame between two sheets of glass, and the outer perimeter of the layer of adhesive is not greater than the perimeter of at least one of the sheets of glass that form a hermetic chamber,
and the layer of adhesive is applied with the possibility of using it as a basis for installing fastening elements, where this possibility is determined by the thickness of the layer of adhesive.

2. Glass package unit according to claim 1, wherein a material based on epoxy resins is used as adhesive.

3. Glass package unit according to claim 1, wherein a polyurethane-based material is used as adhesive.

4. Glass package unit according to claim 1, wherein a plastic adhesive substance capable of hardening is used as adhesive.
